(19) United States
(12) Patent Application Publication
(10) Pub. No.: US 2020/0231497 A1
(43) Pub. Date: Jul. 23, 2020

(54) IMPROVED METHOD FOR ADHERING GLASS TO METAL MOUNTING BRACKETS

(71) Applicant: Dow Global Technologies LLC, Mildland, MI (US)

(72) Inventors: Andrew R. Kneisel, Clarkston, MI (US); Daniel J. Mclain, Lake Orion, MI (US); Michelle M. Henderson, Macomb, MI (US)

(21) Appl. No.: 15/757,882

(22) PCT Filed: Sep. 8, 2016
(86) PCT No.: PCT/US2016/050656

§ 371 Date: Mar. 6, 2018

Related U.S. Application Data
(60) Provisional application No. 62/218,009, filed on Sep. 14, 2015.

(51) Int. Cl. C03C 27/04

(52) U.S. Cl. CPC C03C 27/048; B60J 7/043

(57) ABSTRACT

A method for mounting a metal substrate to a first substrate comprises a metal substrate having a plurality of through holes in at least a portion of the metal substrate and the application of a one part moisture curing adhesive on the adherend first surface, adherend metal surface or both. The first substrate and metal substrate are contacted interposing the adhesive between the adherend first surface and the adherend metal surface such that a portion of the length of at least one through hole is penetrated by the adhesive. The adhesive is cured in the presence of moisture.

### FIELD OF THE INVENTION

The invention relates to an improved method of mounting metal brackets to glass, plastic or ceramic such as used in sunroofs. In particular it is directed to a method of mounting the metal bracket using a one component moisture cure adhesive without the need for any mechanical or adhesive fixtures while the adhesive cures.

### BACKGROUND OF THE INVENTION

Sunroofs are typically comprised of glass and metal brackets that are mounted to the glass. The metal brackets are attached to further hardware to allow for the sun-roof to be opened and closed in various ways. The metal brackets are adhered to the glass using an adhesive that has sufficient strength but is elastic enough to cushion the glass subject to the jarring and strains in an automobile. Generally, these brackets have been mounted via one part polyurethane adhesives. Unfortunately, this has required long curing times, losses due to movement of the bracket on the glass (out of dimensional tolerance) and need for large curing racks and rooms.

Methods of mounting metal or other hardware to glass have been described, such as in U.S. Pat. No. 5,551,197, which describes mounting an articulated hinge to an automobile vent window. The method requires the use of some initial fixturing means such as a rapid curing adhesive or mechanical mounting.

It would be desirable to provide a simple method of affixing glass to a metal bracket that avoids one or more of the problems described in the aforementioned. In particular, it would be desirable to provide a method where a metal bracket could be affixed to glass in short time and be handled yet providing the mechanical properties needed for sunroofs.

### SUMMARY OF THE INVENTION

A first aspect of the invention is an improved method for mounting a metal substrate to a substrate comprising,
(i) providing a first substrate having an adherend first surface and a metal substrate having a thickness and an adherend metal surface wherein the metal substrate has a plurality of through holes each having a cross-sectional area and length through the thickness,
(ii) applying a one part moisture curing adhesive on the adherend first surface, adherend metal surface or both,
(iii) contacting the first substrate and metal substrate such that the one part moisture curing adhesive is interposed between the adherend first surface and the adherend metal surface and said adhesive penetrates into a portion of the length of at least one through hole, and
(iv) allowing the one part moisture curing adhesive to cure.

A second aspect of the invention is a sunroof made by the method of the first aspect.

### BRIEF DESCRIPTION OF THE DRAWINGS

FIG. 1 is a perspective depiction of an assembled structure (e.g., sunroof assembly) made using the method of the invention.

FIG. 2 is a blow up cross-sectional depiction of the first substrate and metal substrate in the vicinity of the through holes after contacting the adhesive.

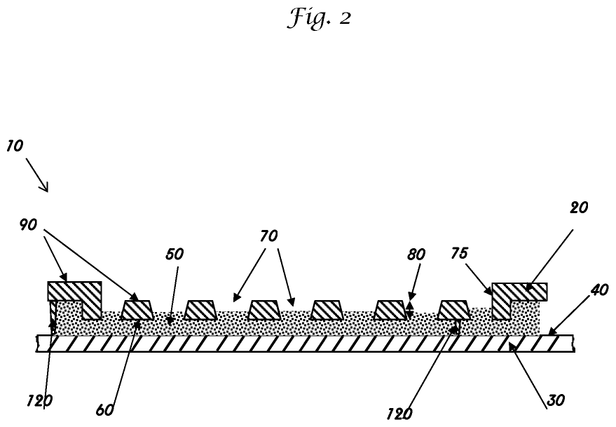

FIG. 3 is the shear load versus displacement curve after 6 hours curing of the adhesive for the Example and Comparative Example of the invention.

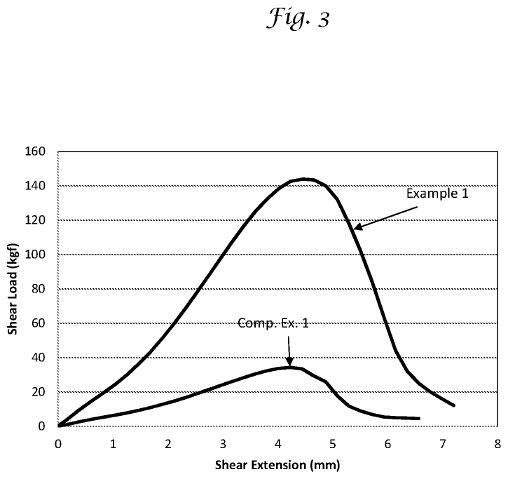

### DETAILED DESCRIPTION OF THE INVENTION

The method of the invention is useful to mount metal substrates 20 such as brackets to a first substrate 30 to make an assembled structure 10. The method is particularly useful to make assembled structures such as sunroofs, hinge mechanisms and mirror mounts.

In the method, the first substrate 30 has an adherend first surface 40 in which the adhesive 50 (one part moisture curing adhesive) is contacted when mounting the metal substrate 20 to the first substrate 30. The metal substrate 20 is contacted with the adhesive 50 on its adherend metal surface 60. The metal substrate 20 has a plurality of through holes 70. The through holes 70 have wall 75 that define a length 80 that typically is equivalent to the thickness of the metal substrate 20 except when the through holes 70 do not orthogonally traverse from the metal adherend surface 60 to the opposite metal surface 90 of the metal substrate 20.

The first substrate 30 may be any ceramic, plastic (e.g., polycarbonate, polyester or the like that may be coated with a ceramic frit), inorganic glass useful in making windows for building and vehicles such as those known in the art. The first substrate may have a glass frit that may be used for decoration, to mask underlying structures and to provide protection from UV radiation.

Glass frits generally are divided into two main categories based on the process to make automotive window glass: sag bent and press bent frits. In the sag bending process, a flat piece of glass is placed atop a mold and heated to the viscoelastic phase, in which it is sufficiently malleable to allow deformation into the desired shape under the action of gravity. In the press bending process, glass sheets are heated and then pressed into a mold using a pressing ram coated with refractory fibers (metal or higher melting fiber glass). The fiber aids release of the bent glass frit from the pressing ram.

In both processes, an inorganic frit composed of particulates of differing oxides are deposited on the periphery of the window. During the bending process the frits fuse and melt forming a black band around the window. The sag bend frits generally are amorphous and smoother than press bent frits. Press bent frits commonly are seeded with crystallization nucleation agents that cause the frit to at least in part crystallize after fusing to aid, for example, in reducing or eliminating sticking of the pressing ram. In contrast, sag bent frits are almost always amorphous. Because press bent frits have been formulated to eliminate sticking of the pressing ram, press bent glass is and has been more difficult to bond into a vehicle.

The metal substrate 20 may be any metal suitable to make a bracket to make the assembled structure. Metals include iron and aluminum and their alloys typically used in vehicular manufacture.

In performing the method, the one part moisture curing adhesive 50 is applied to the first substrate 30, metal substrate 20 or both. The adhesive 50 may be applied by any method such as using a dispensing gun employing a cartridge of the adhesive. Alternatively, a bulk tank and pump apparatus may be used when the volume warrants it.

The thickness of the adhesive 50 applied to the first substrate 30, metal substrate 20 or both may vary depending on the shape of the metal substrate 20. For example, the thickness of the adhesive may be thinner where the through holes 70 are located in the metal substrate 20.

The one part moisture curing adhesive 50 may be any suitable one such as those known in the art. For example, the adhesive may be one in which an isocyanate terminate polyurethane prepolymer is incorporated or silyl terminated polymers such as those known in the art and described in US 2002/0115770.

Preferably, the one part moisture curing adhesive is one in which isocyanate terminated based prepolymers are present in sufficient quantity to provide adhesive character to the adhesive 50. Such prepolymers have an average isocyanate functionality sufficient to allow the preparation of a crosslinked polyurethane upon cure and not so high that the polymers are unstable. “Stability” in this context means that the prepolymer or adhesive prepared from the prepolymer has a shelf life of at least three months at ambient temperature, in that it does not demonstrate an increase in viscosity during such period which prevents its dispensing, application or use. For example, the viscosity should not rise too greatly to make it impractical to dispense the adhesive 50. Preferably, adhesive 50 does not undergo an increase in viscosity of more than about 50 percent during the stated period.

The prepolymer of the adhesive 50 desirably has a total NCO content which facilitates acceptable strength in adhesives prepared from the prepolymers after 60 minutes and stability of the prepolymer. Total NCO content includes the NCOs from the isocyanate terminated prepolymer or unreacted isocyanates used to make the prepolymers. Preferably, the NCO content is about 0.6 percent by weight or greater based on the weight of the prepolymer and more preferably about 0.9 percent by weight or greater, and preferably about 4.0 percent by weight or less, more preferably about 3.5 percent by weight or less, even more preferably about 3.0 percent by weight or less, and even more preferably about 2.6 percent by weight or less. If the prepolymer has greater than about 4.0 percent by weight, the dispensed adhesive 50 may demonstrate lap shear strengths after 60 minutes that may be too low for the intended use. Below about 0.6 percent by weight, the prepolymer viscosity may be too high to handle and the working time may be too short even if dispensable.

Preferable polyisocyanates for use in preparing the prepolymer include those disclosed in U.S. Pat. No. 5,922,809 at column 3, line 32 to column 4, line 24, incorporated herein by reference. Preferably, the polyisocyanate is an aromatic or cycloaliphatic polyisocyanate such as diphenylmethane-4,4′-diisocyanate, isophorone diisocyanate, tetramethylxylene diisocyanate, and is most preferably diphenylmethane-4,4′-diisocyanate. The diols and triols are generically referred to as polyols.

The prepolymers are made from polyols such as diols and triols such as those described in U.S. Pat. No. 5,922,809 at column 4, line 60 to column 5, line 50, incorporated herein by reference. The polyols (diols and triols) are polyether polyols and more preferably polyoxyalkylene oxide polyols. The most preferred triols are ethylene oxide-capped polyols prepared by reacting glycerin with propylene oxide, followed by reacting the product with ethylene oxide.

Preferably, the polyether is chosen to decrease the polarity of the prepolymer. A significant factor in determining the polarity of the prepolymer is the amount of ethylene oxide units in the polyether used to prepare the prepolymer. Preferably, the ethylene oxide content in the prepolymer is about 3 percent by weight or less, more preferably about 1.2 percent by weight or less and most preferably about 0.8 percent by weight or less. As used herein “polarity” refers to the impact of the presence of polar groups in the backbone of the prepolymer. It is also understood that a small amount of other polyols may be used to form the polyether prepolymer such as a polyester polyol such as those known in the art. Typically, such other polyols may be present in an amount of about up to 5% by weight of the polyols used to make said prepolymer. However, said prepolymer may be made in the absence of such polyols.

Generally, the adhesive 50 having the prepolymer includes a filler such as a carbon black. The carbon blacks, depending on their structure and the molecular weight of the prepolymers, may range over a wide range of structures as given by oil absorption number (ASTM D-2414-09). For example, the carbon black typically desirably has an oil absorption number (OAN) of about 80 to 200 ccs per 100 grams, when the Mz of the prepolymer is about 65,000. Preferably, the oil absorption of the carbon is at least about 90, more preferably at least about 100, and most preferably at least about 110 to preferably at most about 180, more preferably at most about 165 and most preferably at most about 150 ccs/100 grams.

The amount of carbon black suitable may be determined for a given carbon black and prepolymer Mz, by routine experimentation. Typically, the amount of carbon black is at least in ascending desirability, 10%, 15%, 18%, 23 or 25% to at most, in ascending desirability, 38%, 35%, 32%, 30% or 28% by weight of the adhesive composition.

The carbon black used may be a standard carbon black which is not specially treated to render it nonconductive. Standard carbon black is carbon black which is not specifically surface treated or oxidized.

Alternatively, one or more nonconductive carbon blacks may be used exclusively or in conjunction with the standard carbon black. Suitable standard carbon blacks include RAVEN™ 790, RAVEN™ 450, RAVEN™ 500, RAVEN™ 430, RAVEN™ 420 and RAVEN™ 410 carbon blacks available from Colombian and CSX carbon blacks such as ELFTEX 55100 and 57100 and MONARCH 120, 570, and 590 available from Cabot, and PRINTEX™ 30 carbon black available from Evonik Industries, Mobile, Ala. Suitable non-conductive carbon blacks include RAVEN™ 1040 and RAVEN™ 1060 carbon black available from Colombian Chemicals Company, Marietta, Ga.

The adhesive 50 may also be comprised of reactive silicon. The reactive silicon may be present as a separate molecule such as a silane. It may be present within the backbone or as a terminal group in the prepolymer described above. The reactive silicon, generally is one that can undergo hydrolysis such as described at column 4, lines 25-55 of U.S. Pat. No. 6,613,816. Other illustrative reactive silicons may be found in U.S. Patent Publication 2002/0100550 paragraphs 0055 to 0065 and Hsieh, U.S. Pat. No. 6,015,475, column 5, line 27 to column 6, line 41, incorporated herein by reference.

The amount of reactive silicon, when present in the adhesive 50 is, generally, about 0.001% to 2% by weight of the total weight of the adhesive 50. The amount of the reactive silicon (note, the weight of the silicon itself and does not include, for example, the organic groups appended thereto), may be at least 0.005%, 0.01%, 0.02%, 0.04%, 0.06%, 0.08% or 0.1% to at most 1.8%, 1.6%, 1.4%, 1.2%, 1%, 0.8%, 0.5% of the adhesive 50.

The adhesive 50 may also be comprised of one or more organic based polymers dispersed therein. Preferably, the organic based polymer is included in the prepolymer by inclusion of a dispersion triol having dispersed therein particles of an organic based polymer. Dispersion triols typically are understood to have at least a portion of the particles being grafted with the polyol. The preferable dispersion triols are disclosed in Zhou, U.S. Pat. No. 6,709,539 at column 4, line 13 to column 6, line 18, incorporated herein by reference. Preferably, the triol used to disperse the organic particles is a polyether triol and more preferably a polyoxyalkylene based triol. Preferably, such polyoxyalkylene oxide triol comprises a polyoxypropylene chain with a polyoxyethylene end cap. Preferably, the triols used have a molecular weight of about 4,000 or greater, more preferably about 5,000 or greater and most preferably about 6,000 or greater. Preferably, such triol has molecular weight of about 8,000 or less and more preferably about 7,000 or less. It is understood that the polyol of the dispersion polyol (e.g., triol) is included in the polyol to make the prepolymer composition described herein, where the copolymer particles of the dispersion polyol are understood to be fillers in the composition.

Preferably, the particles dispersed in the dispersion triol comprise a thermoplastic polymer, rubber-modified thermoplastic polymer or a polyurea dispersed in a triol. The polyurea preferably comprises the reaction product of a polyamine and a polyisocyanate. Preferable thermoplastic polymers are those based on monovinylidene aromatic monomers and copolymers of monovinylidene aromatic monomers with conjugated dienes, acrylates, methacrylates, unsaturated nitriles or mixtures thereof. The copolymers can be block or random copolymers. More preferably, the particles dispersed in the triol comprise copolymers of unsaturated nitriles, conjugated dienes and a monovinylidene aromatic monomer, a copolymer of an unsaturated nitrile and a monovinylidene aromatic monomer or a polyurea. Even more preferably, the particles comprise a polyurea or polystyrene-acrylonitrile copolymer with the polystyrene-acrylonitrile copolymers being most preferred. The organic polymer particles dispersed in the triol preferably have a particle size which is large enough to improve the impact properties and elastomeric properties of the finally cured adhesive, but not so large so as to reduce the ultimate strength of the adhesive after cure. The particles may be dispersed in the triol or grafted to the backbone to at least a portion of the triols if not all of them. Preferably, the particle size is about 10 microns or greater and more preferably the particle size is about 20 microns or greater.

Preferably, the particle size is about 50 microns or less and more preferably the particle size is about 40 microns or less. The triol dispersion contains a sufficient amount of organic polymer particles such that the adhesive upon cure has sufficient hardness for the desired use and not so much such that the cured adhesive has too much elasticity as defined by elongation. Preferably, the dispersion contains about 20 percent by weight or greater of organic polymer particles copolymer based on the dispersion, preferably about 30 percent by weight or greater and more preferably about 35 percent by weight or greater. Preferably, the dispersion contains about 60 percent by weight or less of organic polymer particles based on the dispersion, preferably about 50 percent by weight or less and more preferably about 45 percent by weight or less. The polyols are present in an amount sufficient to react with most of the isocyanate groups of the isocyanates leaving enough isocyanate groups to correspond with the desired free isocyanate content of the prepolymer. Preferably, the polyols are present in an amount of about 30 percent by weight or greater based on the prepolymer, more preferably about 40 percent by weight or greater and most preferably about 55 percent by weight or greater. Preferably, the polyols are present in an amount of about 75 percent by weight or less based on the prepolymer, more preferably about 65 percent by weight or less and most preferably about 60 percent by weight or less.

Generally, the adhesive 50 typically has a ratio of diols to triols and dispersion triols to achieve the desired cure rate and strength of the adhesive. The weight ratio of diol to triol and dispersion triol, if present, is preferably about 0.8 or greater and more preferably about 0.85 or greater and most preferably about 0.9 or greater. The weight ratio of diol to triol and dispersion triol, if present, is preferably about 3.0 or less; more preferably about 2.0 or less and most preferably about 1.75 or less. In the embodiment where the polyols comprise a mixture of diols and triols, the amount of diols present is preferably about 15 percent by weight or greater based on the prepolymer, more preferably about 25 percent by weight or greater and most preferably about 28 percent by weight or greater; and about 40 percent by weight or less based on the prepolymer, more preferably about 35 percent by weight or less and most preferably about 30 percent by weight or less. In the embodiment where the polyols comprise a mixture of diols and triols, the total amount of triols (non dispersion triol and dispersion triol) present is preferably about 15 percent by weight or greater based on the prepolymer, more preferably about 18 percent by weight or greater and most preferably about 20 percent by weight or greater; and preferably about 45 percent by weight or less based on the prepolymer, more preferably about 35 percent by weight or less and most preferably about 32 percent by weight or less.

The dispersion of organic polymer particles in a triol may be present in the prepolymer in an amount of about 10 percent by weight or greater of the prepolymer and more preferably about 12 percent by weight or greater, and about 18 percent by weight or less of the prepolymer and more preferably about 15 percent by weight or less.

The prepolymers may be prepared by any suitable method, such as bulk polymerization and solution polymerization. The reaction to prepare the prepolymer is carried out under anhydrous conditions, preferably under an inert atmosphere such as a nitrogen blanket and to prevent crosslinking of the isocyanate groups by atmospheric moisture. The reaction is preferably carried out at a temperature between about 0° C. and about 150° C., more preferably between about 25° C. and about 90° C., until the residual isocyanate content determined by titration of a sample is very close to the desired theoretical value. “Isocyanate content” means the weight percentage of isocyanate moieties to the total weight of the prepolymer. The reactions to prepare the prepolymer may be carried out in the presence of urethane catalysts. Examples of such include the stannous salts of carboxylic acids, such as stannous octoate, stannous oleate, stannous acetate, and stannous laurate. Also, dialkyltin dicarboxylates such as dibutyltin dilaurate and dibutyltin diacetate are known in the art as urethane catalysts, as are tertiary amines and tin mercaptides. Preferably, the reaction to prepare the prepolymer is catalyzed by stannous octoate. The amount of catalyst employed is generally between about 0.005 and about 5 parts by weight of the mixture catalyzed, depending on the nature of the isocyanate. Preferably, the reaction is carried out in admixture with a plasticizer.

The polyurethane prepolymers useful in the adhesive 50 may further comprise a plasticizer. The plasticizers may be used so as to modify the rheological properties to a desired consistency. Such materials should be free of water and inert to isocyanate groups. The plasticizers may be common plasticizers useful in polyurethane adhesive applications and well known to those skilled in the art and are referred hereinafter as low polar plasticizers. The plasticizer is present in an amount sufficient to disperse the prepolymer of adhesive 50. The plasticizer can be added to the prepolymer either during preparation of the prepolymer or during compounding of the prepolymer prior to being placed into the first compartment. Preferably, the plasticizer is present in about 1 percent by weight or greater of the prepolymer formulation (prepolymer plus plasticizer), more preferably about 20 percent by weight or greater and most preferably about 30 percent by weight or greater. Preferably, the plasticizer is present in about 45 percent by weight or less of the prepolymer formulation and more preferably about 35 percent by weight or less.

Preferably two plasticizers are used, with one being a high polar plasticizer and one being a low polar plasticizer. A high polar plasticizer is a plasticizer with a polarity greater than the polarity of the aromatic diesters, such as the phthalate esters. A low polar plasticizer is a plasticizer which has a polarity the same as or less than the aromatic diesters.

Suitable high polar plasticizers include one or more of alkyl esters of sulfonic acid, alkyl alkylethers diesters, polyester resins, polyglycol diesters, polymeric polyesters, tricarboxylic esters, dialkylether diesters, dialkylether aromatic esters, aromatic phosphate esters, and aromatic sulfonamides. More preferred high polar plasticizers include aromatic sulfonamides, aromatic phosphate esters, dialkyl ether aromatic esters and alkyl esters of sulfonic acid. Most preferred high polar plasticizers include alkyl esters of sulfonic acid and toluene-sulfamide. Alkyl esters of sulfonic acid include alkylsulphonic phenyl ester available from Lanxess under the trademark MESAMOLL. Aromatic phosphate esters include PHOSFLEX™ 31 L isopropylated triphenyl phosphate ester, DISFLAMOLL™ DPO diphenyl-2-ethyl hexyl phosphate, and DISFLAMOLL™ TKP tricresyl phosphate. Dialkylether aromatic esters include BENZOFLE™ 2-45 diethylene glycol dibenzoate. Aromatic sulfonamides include KETJENFLE™ 8 o and p, N-ethyl toluenesulfonamide.

Suitable low polar plasticizers include one or more aromatic diesters, aromatic triesters, aliphatic diesters, epoxidized esters, epoxidized oils, chlorinated hydrocarbons, aromatic oils, alkylether monoesters, naphthenic oils, alkyl monoesters, glyceride oils, parraffinic oils and silicone oils. Preferred low polar plasticizers include alkyl phthalates, such as diisononyl phthalates, dioctylphthalate and dibutylphthalate, partially hydrogenated terpene commercially available as “HB-40”, epoxy plasticizers, chloroparaffins, adipic acid esters, castor oil, toluene and alkyl naphthalenes. The most preferred low polar plasticizers are the alkyl phthalates.

The amount of low polar plasticizer in the adhesive composition is that amount which gives the desired rheological properties and which is sufficient to disperse the catalyst in the system. The amounts disclosed herein include those amounts added during preparation of the prepolymer and during compounding of the adhesive. Preferably, low polar plasticizers are used in an amount of about 5 parts by weight or greater based on the weight of adhesive 50, more preferably about 10 parts by weight or greater, and most preferably about 18 parts by weight or greater. The low polar plasticizer is preferably used in an amount of about 40 parts by weight or less based on the total amount of adhesive 50, more preferably about 30 parts by weight or less and most preferably about 25 parts by weight or less.

The amount of high polar plasticizer in adhesive 50 is that amount which gives the desired rheological properties. Preferably, the high polar plasticizers are used in the adhesive 50 in an amount of about 0.2 parts by weight or greater based on the weight of adhesive 50, more preferably about 0.5 parts by weight or greater, and most preferably about 1 part by weight or greater. The high polar plasticizer is preferably used in an amount of about 20 parts by weight or less based on the total amount of the adhesive composition, more preferably about 12 parts by weight or less and most preferably about 8 parts by weight or less.

The prepolymer of adhesive 50 may be prepared by any suitable method, such as by reacting polyols, such as diols, triols and optionally dispersion triols such as a copolymer polyol or grafted triol, with an excess over stoichiometry of one or more polyisocyanates under reaction conditions sufficient to form a prepolymer having isocyanate functionality and free isocyanate content which meets the criteria discussed above. In a preferable method used to prepare the prepolymer, the polyisocyanates are reacted with one or more diols, one or more triols and, optionally, one or more dispersion triols. Preferable processes for the preparation of the prepolymers are disclosed in U.S. Pat. No. 5,922,809 at column 9, lines 4 to 51, incorporated herein by reference. The polyurethane prepolymers are present in an amount sufficient such that when the resulting dispensed adhesive 50 is dispensed and cure, substrates are bound together. Preferably, the polyurethane prepolymers are present in an amount of about 20 parts by weight of the adhesive 50 or greater, more preferably about 30 parts by weight or greater and most preferably about 35 parts by weight or greater. Preferably, the polyurethane prepolymers are present in an amount of about 60 parts by weight of the adhesive 50 or less, more preferably about 50 parts by weight or less and even more preferably about 45 parts by weight or less.

Adhesive 50 may further comprise a polyfunctional isocyanate, for example, may improve the modulus of the composition in the cured form or adhesion of the adhesion composition to particular substrates such as painted substrates. “Polyfunctional” as used in the context of the isocyanates refers to isocyanates having a functionality of 2 or greater. The polyisocyanates can be any monomeric, oligomeric or polymeric isocyanate having a nominal functionality of about 2.5 or greater. More preferably, the polyfunctional isocyanate has a nominal functionality of about 2.7 or greater. Preferably, the polyfunctional isocyanate has a nominal functionality of about 5 or less, even more preferably about 4.5 or less and most preferably about 3.5 or less. The polyfunctional isocyanate can be any isocyanate which is reactive with the isocyanate polyisocyanate prepolymers used in the composition and which improves the modulus of the cured composition. The polyisocyanates can be monomeric; trimeric isocyanurates or biurets of monomeric isocyanates; oligomeric or polymeric, the reaction product of several units of one or more monomeric isocyanates. Examples of preferred polyfunctional isocyanates include trimers of hexamethylene diisocyanate, such as those available from Bayer under the trademark and designation DESMODUR N3300 and N100, and polymeric isocyanates such as polymeric MDI (methylene diphenyl diisocyanates) such as those marketed by The Dow Chemical Company under the trademark of PAPI, including PAPI 20 polymeric isocyanate. The polyfunctional isocyanates, when present, are typically present in an amount sufficient to impact the modulus of the cured compositions of the invention or improve the adhesion to certain substrates described above. The polyfunctional isocyanate, when present, is preferably present in an amount of about 0.5 parts by weight or greater based on the weight of the adhesive composition, more preferably about 1.0 parts by weight or greater and most preferably about 2 parts by weight or greater. The polyfunctional isocyanate is preferably present in an amount of about 8 parts by weight or less, based on the weight of the adhesive composition, more preferably about 5 parts by weight or less and most preferably about 4 parts by weight or less.

Adhesive 50 may also contain a catalyst which catalyzes the reaction of isocyanate moieties with water or an active hydrogen containing compound. Such compounds are well known in the art. The catalyst can be any catalyst known to the skilled artisan for the reaction of isocyanate moieties with water or active hydrogen containing compounds. Among preferred catalysts are organotin compounds, metal alkanoates, and tertiary amines. Mixtures of classes of catalysts may be used. A mixture of a tertiary amine and a metal salt is preferred. Even more preferred are tertiary amines, such as dimorpholino diethyl ether, and a metal alkanoate, such as bismuth octoate. Included in the useful catalysts are organotin compounds such as alkyl tin oxides, stannous alkanoates, dialkyl tin carboxylates and tin mercaptides. Stannous alkanoates include stannous octoate. Alkyl tin oxides include dialkyl tin oxides, such as dibutyl tin oxide and its derivatives. The organotin catalyst is preferably a dialkyltin dicarboxylate or a dialkyltin dimercaptide. Dialkyltin dicarboxylates with lower total carbon atoms are preferred as they are more active catalysts in the compositions of the invention. The preferred dialkyl dicarboxylates include 1,1-dimethyltin dilaurate, 1,1-dibutyltin diacetate and 1,1-dimethyl dimaleate. Preferred metal alkanoates include bismuth octoate or bismuth neodecanoate. The organotin or metal alkanoate catalyst is present in an amount of about 60 parts per million or greater based on the weight of the adhesive, and more preferably 120 parts by million or greater. The organotin catalyst is present in an amount of about 1.0 percent or less based on the weight of the adhesive 50, more preferably 0.5 percent by weight or less and most preferably 0.1 percent by weight or less.

Useful tertiary amine catalysts include dimorpholinodialkyl ether, a di((dialkylmorpholino)alkyl) ether, bis-(2-dimethylaminoethyl)ether, triethylene diamine, pentamethyldiethylene triamine, N,N-dimethylcyclohexylamine, N,N-dimethyl piperazine 4-methoxyethyl morpholine, N-methyl-morpholine, N-ethyl morpholine and mixtures thereof. A preferred dimorpholinodialkyl ether is dimorpholinodiethyl ether. A preferred di((dialkylmorpholino)alkyl) ether is (di-(2-(3,5-dimethylmorpholino)ethyl)ether). Tertiary amines are preferably employed in an amount, based on the weight of the adhesive of about 0.01 parts by weight or greater, more preferably about 0.05 parts by weight or greater, even more preferably about 0.1 parts by weight or greater and most preferably about 0.2 parts by weight or greater and about 2.0 parts by weight or less, more preferably about 1.75 parts by weight or less, even more preferably about 1.0 parts by weight or less and most preferably about 0.4 parts by weight or less.

Adhesive 50 may be formulated with fillers other than the carbon black and additives known in the prior art for use in adhesive compositions. By the addition of such materials, physical properties such as viscosity flow rates and the like can be modified. However, to prevent premature hydrolysis of the moisture sensitive groups of the polyurethane prepolymer, fillers should be thoroughly dried before admixture therewith.

Further optional components in adhesive 50 may include reinforcing fillers. Such fillers may include those known in the art and including, for example, titanium dioxide, calcium carbonate, surface treated silicas, titanium oxide, fumed silica, talc, and the like. In one embodiment, more than one reinforcing filler may be used. The reinforcing fillers are typically used in an amount sufficient to increase the strength of the adhesive 50.

Optional fillers may include clays. Preferred clays include kaolin, surface treated kaolin, calcined kaolin, aluminum silicates and surface treated anhydrous aluminum silicates. The clays can be used in any form, which facilitates formulation of the adhesive 50. Preferably, the clay is in the form of pulverized powder, spray-dried beads or finely ground particles. Clays may be used in an amount of about 0.1 parts by weight of the adhesive composition or greater, more preferably about 12 parts by weight or greater and even more preferably about 18 parts by weight or greater. Preferably, the clays are used in an amount of about 30 parts by weight or less of the adhesive composition, more preferably about 28 parts by weight or less and most preferably about 24 parts by weight or less.

Adhesive 50 may further comprise stabilizers, which function to protect the prepolymer from moisture, thereby inhibiting advancement and preventing premature crosslinking of the isocyanates in the Adhesive 50. Stabilizers known to the skilled artisan for moisture curing adhesives may be used. Included among such stabilizers are diethylmalonate, alkylphenol alkylates, paratoluene sulfonic isocyanates, benzoyl chloride and orthoalkyl formates. Such stabilizers are preferably used in an amount of about 0.1 parts by weight or greater based on the total weight of the adhesive 50, preferably about 0.5 parts by weight or greater and more preferably about 0.8 parts by weight or greater. Such stabilizers are used in an amount of about 5.0 parts by weight or less based on the weight of the adhesive composition, more preferably about 2.0 parts by weight or less and most preferably about 1.4 parts by weight or less.

After applying the adhesive 50, the first substrate 30 and metal substrate 20 are contacted interposing the adhesive 50 such that the adhesive 50 penetrates into a portion of the length 80 of at least one through hole 70. The portion of the length 80 that is penetrated is desirably less than 50% of the length 80 to essentially just penetrated (i.e., ˜1%). It has been discovered that this is particularly desirable to realize an assembled structure where the metal substrate 20 quickly adheres to the first substrate 30 with sufficient strength and stiffness in the area of the holes preventing lateral movement that may occur during handling of the assembled structure as the adhesive cures. Desirably, the portion of the length 80 of the through holes penetrated by the adhesive is at most 40%, 30%, 20% to at least 2%, 5% or 10%. It is also preferred that a majority of the holes have been penetrated by the adhesive. Even more preferably, at least 60%, 70%, 80%, 90% or essentially all of the through holes 70 are penetrated by the adhesive 50.

In a preferred embodiment, the through holes 70 have a smaller cross-sectional area at the adherend metal surface 60 than at the opposite metal surface 90. It is believed that this configuration of the through holes may aid the rapid curing of the adhesive 50 while also enhancing the resistance to lateral movement of the metal substrate 20 at the early stages of curing of the adhesive 50. Desirably, when the cross-sectional area of the through hole at the adherend metal surface 60 is less than the cross-sectional area of the through hole at the opposite metal surface, the ratio of these areas is less than 1 to about 0.95, 0.9, 0.8, 0.7, 0.6 or 0.5. Preferably, the ratio is from 0.95 to about 0.8.

The through holes 70 may have any cross-sectional shape such as a polygon (e.g., square, rectangle, triangle, pentagon and the like), oval or circle. The through holes 70 have a cross-sectional area sufficiently large enough to allow for the rapid curing and quick handling of the assembled structure 10. Generally, a cross-sectional area of about 5 mm² to about 50 mm² to 25 mm² is suitable. The pattern of the holes may be any that is useful. The pattern typically will have a pitch of about 1 mm to about 50, 30 or 20 mm from center to center of each through hole 70 and depending on the cross-sectional area of the through holes 70.

In an embodiment, the one part moisture curing adhesive 50 has a bond thickness between the adherend first surface 40 and adherend metal surface 60 that is thinner in the portion of the metal substrate 20 having through holes 70 compared to the bond thickness where the metal substrate does not have through holes. Desirably, in this embodiment, the bond thickness where the through holes are present is from about 1% or 5% to 80% of the bond thickness where the through holes are not present. Preferably, the bond thickness where the through holes are present is at most about 50%, 40%, 30% or 20% of the bond thickness where the through holes are not present.

It is also desirable for bond thickness where the through holes are located to be from 20 micrometers to 5, 3, 2, 1, 0.5 or 0.2 millimeters. It has been discovered to be particularly desirable for the bond thickness where the through holes are located to be from 20 micrometers to 500 micrometers and the bond thickness to be greater where the through holes are not present as described above. This is believed to allow for quick handling, while still allowing for the first substrate 30 to be adequately cushioned during use in a vehicle and to achieve desired noise vibration and harshness performance, for example, of a sun-roof.

In performing the method, it is desirable to ensure uniform thickness of the adhesive 50 when adhering the first substrate 30 to the metal substrate 20. Even though this may be accomplished by using automated machinery, to ensure tolerances necessary and to reduce handling variations, standoffs 120 are preferred. Standoffs 120 may be formed directly in the metal substrate 20 such as a dimple pressed into the metal. Alternatively, the standoff may be adhered to the metal substrate. In a preferred embodiment, the standoff is not a metal but a plastic standoff 120 that may be inserted into preexisting hole that may be blind or traverse through the thickness of the metal substrate 20. Generally, at least three standoffs 120 are employed to ensure the uniformity of the metal substrate 20 position on the first substrate 30. Greater amounts of standoffs may be employed, for example, due to the flexibility and size of the metal substrate 20.

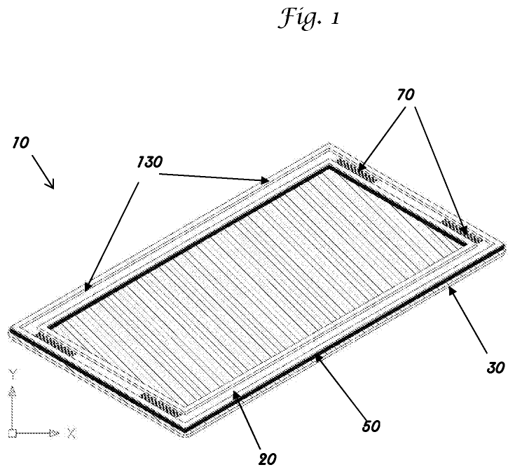

When practicing the method of the present invention, particularly for larger assembled structures 10 having larger metal substrates 20, it has been discovered that it is desirable to have areas 130 in which there are no through holes 70 present as shown in FIG. 1. In such an embodiment, the amount of area having through holes 70 may be only about 5% to 25% of the total area of the adherend surface 60. Likewise, when the metal substrate 20 is in the shape of polygon, it is preferred that the through holes 70 are located near, around or at the vertices of the polygon (e.g., proximate to the corners of the rectangular bracket as shown in FIG. 1).

After the metal substrate 20 and first substrate 30 are contacted with the adhesive 50 interposed therebetween, the adhesive is allowed to cure. The curing generally is at ambient conditions (typically from 20° C. to 40° C. at relative humidities of 5% to essentially saturated). Further heating or moisture saturation may be employed to further accelerate the curing of the moisture cure adhesive 50, such as heating up to about 100° C. It is also preferred that atmosphere has a relative humidity of at least about 20%, 30% or 50%.

### EXAMPLES

### Example 1

Carbon steel substrates were prepared for performing lap shear measurements as per SAE J1529, with the following modifications, a 20 mm overlap×25 mm wide×1 mm thick lap shear test was evaluated with a solid carbon steel substrate and a perforated carbon steel substrate. The perforated substrate had 1.4 mm diameter circular holes spaced 3.3 mm on center. The substrates were adhered using BETASEAL 57302 adhesive, a high viscosity one part moisture curable polyurethane adhesive available from The Dow Chemical Company, Midland, Mich. When adhering the substrates, at least a portion of the holes of the perforated substrate was penetrated by the adhesive. At least three tests were performed.

The average peak load during destructive testing and load at 0.5 mm of extension are shown in Table 1.

### Comparative Example 1

Example 1 was replicated except that both substrates were solid. The same testing was performed and the results are shown in Table 1.

The data in Table 1 shows the positive influence of the perforated joint as the resistance loading is higher with the perforated joints most notably at 6 hours in the prescribed configuration. In addition, the continuous load displacement curve of Example 1 and Comparative Example 1 show the rapid rise in load for Example 1 compared to Comparative Example 1 at 6 hour cure. The curve demonstrates substantial increased loads that would be required to tear and damage the bond in which one of the substrates is perforated. In addition, because Comparative Example 1 even after 24 hours of cure has a lower load at a 0.5 mm extension than Example 1, this shows that if this were incorporated into a sun-roof and the glass was compressed upon the frame with a rubber seal, the adhesive would be compressed and continue to cure in the distorted state, which may cause the sun-roof to leak. In contrast, the Example 1, because of the substantially faster cure exhibited could be incorporated into a sun-roof much faster without having this problem.

TABLE 1

| | | | Load at | Load at |
|---|---|---|---|---|
| | | Average | 0.5 mm | 1 mm |
| | Cure time | Peak Load | extension | extension |
| Example | (hours) | (lbs) | (lbs) | (lbs) |
| 1 | 2 | 21 | 4 | |
| 1 | 4 | 56 | 7.7 | |
| 1 | 6 | 320 | 26.6 | 51.6 |
| 1 | 8 | 509 | 35.9 | |
| 1 | 24 | 604 | 36.6 | |
| Comp. 1 | 2 | 18 | 1.7 | |
| Comp. 1 | 4 | 43 | 3.5 | |
| Comp. 1 | 6 | 76 | 7.3 | 13.8 |
| Comp. 1 | 8 | 114 | 10.3 | |
| Comp. 1 | 24 | 240 | 14 | |

1. A method for mounting a metal substrate to a first substrate comprising,
(i) providing a first substrate having an adherend first surface and a metal substrate having a thickness defined by an adherend metal surface and opposite metal surface wherein the metal substrate has a plurality of through holes in at least a portion of the metal substrate each having a hole surface area, cross-sectional area, and length through the thickness,
(ii) applying a one part moisture curing adhesive on the adherend first surface, adherend metal surface or both,
(iii) contacting the first substrate and metal substrate such that the one part moisture curing adhesive is interposed between the adherend glass surface and the adherend metal surface and said adhesive penetrates into a portion of the length of at least one through hole, and
(iv) allowing the one part moisture curing adhesive to cure.

2. The method of claim 1, wherein a plurality of standoffs are interposed between the first substrate and metal substrate during the contacting.

3. The method of claim 2, wherein the plurality of standoffs are incorporated in the metal substrate.

4. The method of claim 1, wherein the adhesive penetrates from about 1% to 50% of the length of the through hole.

5. The method of claim 4, wherein the adhesive penetrates from about 10% to 40% of the length of the through hole.

6. The method of claim 1, wherein the adhesive penetrates into a portion of the length of at least 50% of the through holes.

7. The method of claim 6, wherein the adhesive penetrates into a portion of the length of at least 90% of the through holes.

8. The method of claim 1, wherein the portion of the metal substrate having through holes is at most about 50% of the metal substrate.

9. The method of claim 8, wherein the one part moisture curing adhesive has a bond thickness between the adherend first surface and adherend metal surface with said bond thickness being thinner in the portion of the metal substrate having through holes compared to the bond thickness where the metal substrate does not have through holes.

10. The method of claim 9, wherein the bond thickness in the portion of the metal substrate having through holes is 5% to 80% of the thickness where the metal substrate does not have through holes.

11. The method of claim 10, wherein the bond thickness in the portion of the metal substrate having through holes is 5% to 50% of the thickness where the metal substrate does not have through holes.

12. The method of claim 1, wherein the adhesive has a bond thickness between the adherend first surface and adherend metal surface from about 20 micrometers to 2 millimeters.

13. The method of claim 1, wherein the metal substrate is a bracket that is in the shape of square or rectangle, wherein the through holes are located proximate to the corners of the bracket.

14. The method of claim 1, wherein the one part moisture curing adhesive is comprised of an isocyanate terminated polyurethane prepolymer, catalyst, and filler.

15. The method of claim 14, wherein the catalyst is comprised of a tertiary amine.

16. The method of claim 14, wherein the one part moisture curing adhesive is further comprised of a compound having reactive silicon groups.

17. The method of claim 16, wherein at least a portion of the reactive silicon groups are hydrolysable silyl groups that are pendant to the isocyanate terminated polyurethane prepolymer.

18. The method of claim 1, wherein the through holes have a cross-sectional area of 1 mm² to 25 mm² and are spaced having a pitch of 1 mm to 20 mm from center to center of the cross-sectional areas of the through holes.

19. The method of claim 18, wherein at least one through hole has a smaller cross-sectional area at the adherend metal surface than at the opposite metal surface.

20. The method of claim 1, wherein the hole surface area is treated to enhance the bonding or wetting of the one part moisture curable adhesive to the hole surface area.
